(19) United States
(12) Patent Application Publication
(10) Pub. No.: US 2022/0210685 A1
(43) Pub. Date: Jun. 30, 2022

(54) ADAPTABLE AND SCALABLE INTELLIGENT NETWORK PACKET BROKER SYSTEM

(71) Applicant: SMVData Inc., San Jose, CA (US)

(72) Inventors: Elias Keshishoglou, Morgan Hill, CA (US); Shay Morag, San Jose, CA (US)

(21) Appl. No.: 17/139,840

(22) Filed: Dec. 31, 2020

(51) Int. Cl. H04W 28/02; H04L 12/803

(52) U.S. Cl. CPC H04W 28/0215; H04L 47/125

(57) ABSTRACT

An example system may include a processor executing instructions to receive, at a smart packet broker from a switch manager, a request instructing the smart packet broker to apply a filter to network traffic processed by a switching system associated with a switch fabric. The switching system may include a plurality of ports and may be configured to switchably couple sets of ports from the plurality of ports. The smart packet broker may further apply the filter to the network traffic using the switching system. The filter may have a set of defined attributes. The smart packet broker may, in some instances, filter data corresponding to the set of defined attributes to the switch manager from the first network traffic.

### BACKGROUND

The present disclosure generally relates to network management and visibility, and by way of example and not limitation, more particularly to packet brokering.

As networks grow in complexity and data throughput, routers and other equipment are being designed to handle larger and larger quantities of network traffic. To control the traffic of data through a network, many networks utilize switches and/or routers. A switch may include one or more input ports and output ports. Data coming into an input port may then be redirected to one or more of the output ports. Conventionally, a switch may receive data at the input port, such as through an ethernet cable or other medium, and distribute the traffic to other locations. To handle these tasks and the growing size and complexity of network traffic, network interface controller devices are including increasingly sophisticated processors.

Conventionally, network visibility on large, complex networks has been performed using expensive, purpose-built network packet brokers (NPBs) that are deployed on specialized hardware devices. A network packet broker utilizes a switch fabric to route data packets to different network locations. However, conventional NPBs utilize proprietary hardware/software implementations that are customized for each specific use. These NPBs are not flexible to adjust to advancing technology and other network changes. This limitation may result in a company replacing their NPBs frequently, which results in significant costs, service interruption, and potential security vulnerabilities.

Furthermore, conventional network tools may be inflexible to and incapable of handling increased network traffic. As network loads increase, conventional network products may need to be replaced with new hardware/software solutions. Given the rapid rate at which network traffic is increasing (currently at doubling every three to five years and that rate is expected to increase significantly), this change will likely result in the rapid depreciation and lifespan of expensive hardware infrastructure due to its lack of scalability. This will likely cause costly, more frequent upgrades, an increase in operating costs, and numerous administration challenges. Further, as 5^{th} generation (5G) and later wireless communication standards become more prevalent, network traffic volume will continue to increase at a rapid rate, which may further exacerbate the foregoing issues.

Accordingly, there is a need for a hardware-agnostic, adaptive, and scalable network tools that are capable of managing and/or tracking network traffic more effectively.

### SUMMARY

The present disclosure overcomes the deficiencies and limitations of the background at least in part by performing operations including receiving, at a first smart packet broker from a switch manager, a first request instructing the first smart packet broker to apply a first filter to first network traffic being processed by a first switching system associated with a switch fabric, the first switching system including a plurality of ports and configured to switchably couple sets of ports from the plurality of ports; applying, by the first smart packet broker, the first filter to the first network traffic using the first switching system, the first filter having a first set of defined attributes; and filtering, from the first network traffic, first data corresponding to the first set of defined attributes to the switch manager.

According to some innovative aspects, the sets of ports includes a first set of ports having a first port mapped to a second port; filtering the first data corresponding to the first set of defined attributes to the switch manager includes determining which packets received at the first port of the first switching system to forward to the second port of the first switching system; and the operations may include, responsive to filtering the first data to the switch manager, receiving, at the first smart packet broker from the switch manager, a second request instructing the first smart packet broker to block one or more of the plurality of ports; and signaling the first switching system to block the one or more of the plurality of ports.

The operations may include one or more of receiving, at a second smart packet broker from the switch manager, a second request instructing the second smart packet broker apply the first filter to second network traffic being processed by a second switching system that is different from the first switching system; applying, by the second smart packet broker, the first filter to the second network traffic using the second switching system; filtering, from the second network traffic, second data corresponding to the first set of defined attributes to the switch manager; receiving, at the first smart packet broker and the second smart packet broker from the switch manager, a second request instructing the first smart packet broker and the second smart packet broker to apply a second filter, the second filter being determined by the switch manager based on the filtered first data and the filtered second data, the second filter having a second set of defined attributes; applying, by the first smart packet broker, the second filter to the first network traffic using the first switching system; filtering, from the first network traffic, third data corresponding to the second set of defined attributes to the switch manager; applying, by the second smart packet broker, the second filter to the second network traffic using the second switching system; and/or filtering, from the second network traffic, fourth data corresponding to the second set of defined attributes to the switch manager.

According to further innovative aspects, the operations may include, responsive to the filtered data being received by the switch manager from other switching systems, receiving, at the first smart packet broker from the switch manager, a second request instructing the first smart packet broker apply a second filter to the first network traffic, the second filter having a second set of defined attributes that is different than the first set of defined attributes of the first filter; applying, by the first smart packet broker, the second filter to the first network traffic using the first switching system; filtering, from the first network traffic, second data corresponding the second set of defined attributes to the switch manager; redistributing further network traffic processed by the switch fabric based on at least the first data filtered to the switch manager; and/or wherein the first switching system comprises a smart network interface card (SmartNIC), a physical network switch, or a virtual network switch.

In another innovative aspect, an example method may include sending, to a first smart packet broker, a first request instructing the first smart packet broker to apply a first filter to first network traffic processed by a first switching system, the first filter having a first set of defined attributes; receiving first filter data corresponding to the first set of defined attributes from the first switching system; detecting, based on the first filter data, a network condition; determining, based on the network condition, a second filter; and/or sending, to the first smart packet broker, a second request instructing the first smart packet broker to apply a second filter to the first network traffic processed by the first switching system, the second filter having a second set of defined attributes that is different from the first set of defined attributes of the first filter.

According to some innovative aspects, the example method may further include receiving second filter data corresponding to the second set of defined attributes from the first switching system; processing the second filter data to confirm the network condition; executing a remedial action to address the network condition; and/or that the network condition includes one or more of an increase in volume of the first network traffic relative to a threshold and a detected pattern of first network traffic that corresponds to a defined pattern. Operations of the method may optionally include sending, to a plurality of other smart packet brokers respectively associated with a plurality of other switching systems, a corresponding first request instructing the plurality of other smart packet brokers to apply the second filter to network traffic processed by the plurality of other smart packet brokers; receiving other first filter data corresponding to the first set of defined attributes from the plurality of other switching systems, wherein detecting the network condition further includes processing the first filter data and the other first filter data corresponding to the first set of defined attributes to detect the network condition; sending, to the plurality of other smart packet brokers, a second request instructing the plurality of other smart packet brokers to apply the second filter to network traffic processed by the plurality of other switching systems; receiving other second filter data corresponding to the second set of defined attributes from the plurality of other switching systems; receiving second filter data corresponding to the second set of defined attributes from the first switching system; and/or processing the second filter data to confirm the network condition; and/or executing a remedial action to address the network condition.

Further innovative aspects may include various other features as discussed herein. Various implementations of these and other innovative aspects may include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for providing a smart packet broker service.

FIG. 2 is a block diagram showing example communications between a switch manager and one or more switches.

FIG. 3A is a block diagram illustrating an example network switch.

FIGS. 3B and 3C are a block diagrams illustrating example communication between a smart packet broker and a switch manager.

FIG. 4 is a block diagram illustrating an example implementation of a multi-level hierarchical structure showing communication between network devices.

FIG. 5 is a signal diagram illustrating example interactions between a switch manager, smart packet broker, and multiple switching systems.

FIG. 6 is an example graphical user interface for developing and/or applying operations using a smart packet broker.

### DETAILED DESCRIPTION

The technology described herein includes innovative network tools, which may be used, for example, for network visibility, extending and repurposing network devices, leveraging edge computing hardware, and providing central control of multiple network interface controllers (NICs) in a flexible, hardware-agnostic, and scalable way. For example, some implementations of the technology described herein allow a switch manager 104 running on a server, virtual machine, switch, NIC processor, or other computing device to control multiple switching systems. The technology may provide adaptable and scalable intelligent network data packet brokering based on traffic volume and complexity of the network using various hardware and/or software solutions, as described in further detail below.

In some implementations, the technology described herein may be software-based and device agnostic. For example, aspects of the technology may be installed on a switch, such as a first-party or third-party (e.g., whitebox) switch, a virtual switch, a SmartNIC, or other suitable devices capable of performing the functionality and acts described herein. In some instances, the technology may beneficially extend the life of/allow old network equipment to be re-used for a different purpose than its original programing allowed, thereby better matching the needs of one or more networks, network filtering, and network visibility. Further, the technology may allow computer-security threats to be assessed and managed across one or multiple networks and/or devices.

In some implementations, the technology may be a network packet broker (also referred to as an NPB or smart packet broker) that may adaptively filter and redirect network traffic in novel ways. For instance, the smart packet broker 108 described herein may be configured to operate on any hardware device that includes switching functionality to forward network traffic between nodes, such as via a switch fabric. While described herein as software-based in several implementations, the smart packet broker 108 may be implemented using hardware, software, or a combination of the foregoing. Network traffic may be monitored, filtered, and redirected using interfaces, such as virtual network interfaces, NICs, etc.

The switch manager 104 described herein may manage various smart packet brokers 108 operating on various computing hardware, such as configuring the by instructing them to implement various filters, filter data back to the switch manager 104 for processing using the filters, take protective action based on the processing, and perform other packet broker functions on network traffic, as described in detail elsewhere herein. While described herein as software-based in several implementations, the switch manager 104 may be implemented using hardware, software, or a combination of the foregoing. Implementations of the technology provide a switch manager 104 and/or smart packet broker 108 that may scalably be implemented on small networks in addition to large, complex, and high-traffic networks.

For example, unique software solutions described herein may allow the technology to be installed on any hardware device having a switching system 130, such as but not limited to a switch, SmartNIC, or other switching device having a switch fabric. This solution may provide significant cost-savings, because old network hardware, such as non-specialized routers and switches 110, may be repurposed by installing the switch manager 104, smart packet broker 108, or components thereof. Furthermore, as a network grows in size and/or complexity, new hardware may be added to the existing system and/or switch devices or devices (e.g., SmartNIC devices or cards) or may be replaced with higher-throughput devices. These new elements may be added to the existing NPB systems, thereby reducing capital and complexity of purchasing new switching or NPB hardware to accommodate each change to the network.

For example, a switch manager 104 and/or smart packet broker 108 may include software components that run on networking hardware operating systems, such as Microsoft's® SONiC™ operating system. The prevalence of the SONiC operating system may further improve the applicability, flexibility, and scalability of software-based aspects of the technology described herein. For example, implementations of the technology may be executed on virtually any hardware having or coupled with a switch fabric, which may allow the switch manager 104 to assign and coordinate logical rules for the smart packet broker 108 on the switch hardware. Accordingly, the technology may turn almost any switch hardware into an intelligent network packet broker. The technology may, therefore, be applied on generic or not-purpose-built hardware, such as switching hardware (e.g., a router, etc.) previously used for other purposes.

For example, a legacy network switch or router having a switching system 130 providing a switch fabric, such as a crossbar silicon switch chip or other suitable switch fabric processor and corresponding network interfaces, may have a smart packet broker 108 and/or switch manager 104 installed thereon to repurpose the router to programmably perform other operations, as described below. Because conventional NPBs may include custom-built hardware/software implementations that can cost millions of dollars, the technology may allow old equipment to be repurposed thereby reducing expense by 90% or more.

Furthermore, the technology described herein provides a scalable solution, for instance, a system may easily scale in size and/or complexity based on available hardware because new hardware, replaceable, higher-throughput interface and/or switch fabric processors, or additional switches 110 or switching systems 130 may be easily added using the technology. Additionally, packet broker, switch, or interface logic can be customized to balance load or perform needed operations.

The technology described herein also provides an adaptive, flexible solution that may allow one or multiple switch managers 104, smart packet brokers 108, or switching systems 130 to adapt to various network conditions and/or advancing technologies. In some implementations, a switch manager 104 may assign or reassign various switching systems 130 to various operations depending on the needs of real-time traffic, for example, the switch manager 104 may communicate with multiple smart packet brokers 108 on various switches 110 in order to dynamically adjust to incoming traffic and/or threats. Accordingly, the switch manager 104 and/or smart packet broker 108 may redistribute network traffic based on a detected network condition. For example, a first smart packet broker 108 may filter data corresponding to a first set of defined attributes defined by a filter (e.g., certain metadata in a packet header, IP address, other packet or traffic characteristics, etc.) to the switch manager 104. The switch manager 104, based on the data filtered to it, may redistribute further network traffic processed by the switch fabric.

The technology described herein can also flexibility and scalably adapt to advancing technologies. For example, advanced generation (e.g., 5G, 6G, +) telecommunication systems may involve an increase in both network traffic volume and network complexity, which may lead to higher traffic volume and network complexity of networks implementing advanced generation compatibility. According to some implementations, a switch manager 104 may increase a quantity or utilization of smart packet brokers 108 and/or switching systems 130 to accommodate the increase in complexity and traffic of an advanced generation, high-throughput network.

As used herein, in addition to its plain and ordinary meaning, a switch may include an accessible operating system, software, and switch hardware including network adapter(s), such as NICs, that are coupled to other network nodes. The switch may be coupled to and comprise at least a portion of a switch fabric. The switch is capable of directing network traffic to and from various network nodes. In a non-limiting example, a switch may comprise a whitebox switch or white label network switch comprised of off-the-shelf or standardized components or may comprise at least some proprietary components. In either case, the switch may allow for third-party software and/or have an operating system with open application programming interfaces (APIs) to extend the functionality of the switch, such as allow for interaction with the switch hardware and data being forwarded thereby. Other variations are also applicable.

As used herein, in addition to its plain and ordinary meaning, a SmartNIC may comprise an edge computing device that has NIC(s) that are coupled to other network nodes and a data processing unit (e.g., application-specific integrated circuit (ASIC), field-programmable gate array (FPGA), and System-on-a-Chip (SOC), etc.) capable of processing and performing functions (e.g., encryption/decryption, firewall, TCP/IP and HTTP processing, etc.) on data at or proximate to the point of transmission (hence edge) at a high rate without substantially impacting the core functions of the SmartNIC. This can beneficially offload processing from a server or other processing unit as well as reduce back and forth communication between the device in which the SmartNIC is installed or associated with and the server and/or or other network devices. A SmartNIC may include an operating system and/or firmware that can be extended similar to the whitebox switch. Other variations are also applicable.

It should be noted that while these features and benefits are described herein, other benefits and features are described and evident in the description of the technology herein.

With reference to the figures, reference numbers may be used to refer to components found in any of the figures, regardless whether those reference numbers are shown in the figure being described. Further, where a reference number includes a letter referring to one of multiple similar components (e.g., component 000a, 000b, and 000n), the reference number may be used without the letter to refer to one or all of the similar components.

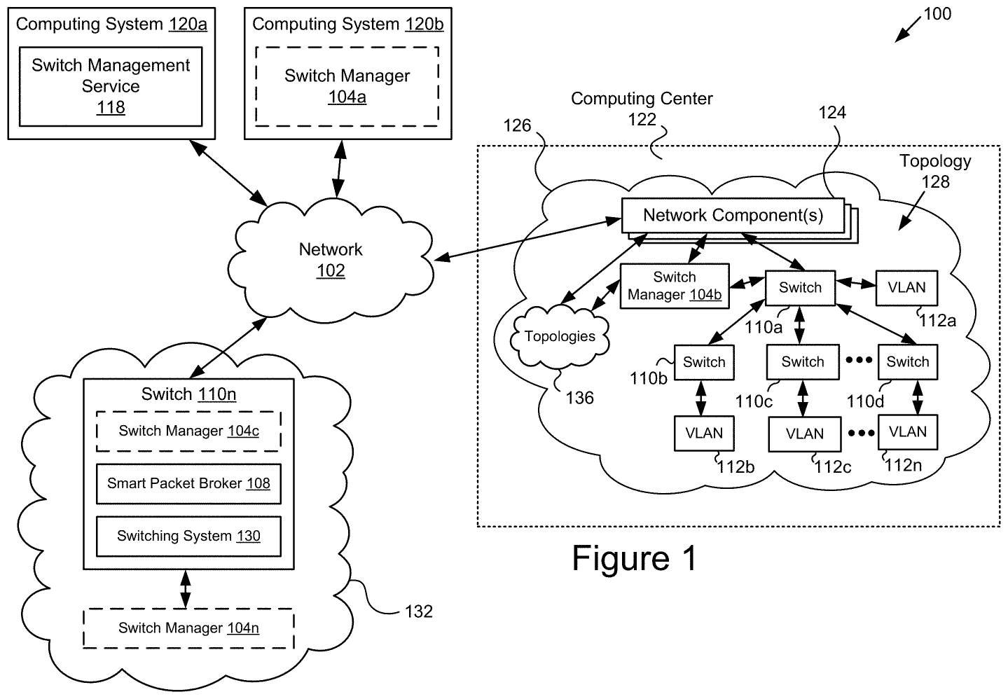

FIG. 1 is a block diagram of an example system 100 for providing a smart packet broker service. For instance, the system 100 may provide software-based configuration and network visibility tools that may be installed on networking hardware (e.g., servers, switches, SmartNICs, etc.) to adaptively and scalable handle varying amounts of network traffic, detect and address vulnerabilities, and automatically remediate issues, depending on network and installation requirements. The system 100 may include one or more of a switch manager 104, a smart packet broker 108, and a switch management service 118 operating on various computing equipment.

As illustrated, the system 100 may include one or more computing system 120 . . . 120b, a computing center, and one or more switches 110a . . . 110n, which may be electronically communicatively coupled via one or more networks 102 for interaction with one another, although other system configurations are possible including other devices, systems, and networks. For example, the system 100 could include any number of computing systems 120, computing centers 122, switches 110, or other systems and devices. Depending on the implementation, one or more instances of a switch manager 104a . . . 104n may run on a computing system 120, switch 110, or computing center 122, although it should be noted that the components or functionality of the switch manager 104 may be distributed across one or more systems. The networks may include any type of topologies including any number and types of networking components and nodes.

A switch 110 may be a network device that includes a processor capable of executing software instructions and switching equipment. As illustrated, a switch 110n may include one or more of a switch manager 104c, a smart packet broker 108, and a switching system 130. For example, a switch 110 may be any computing device that includes switching hardware or software, such as a router or other networking hardware. Implementations of switches 110 are shown and described in further detail below in reference to other figures herein.

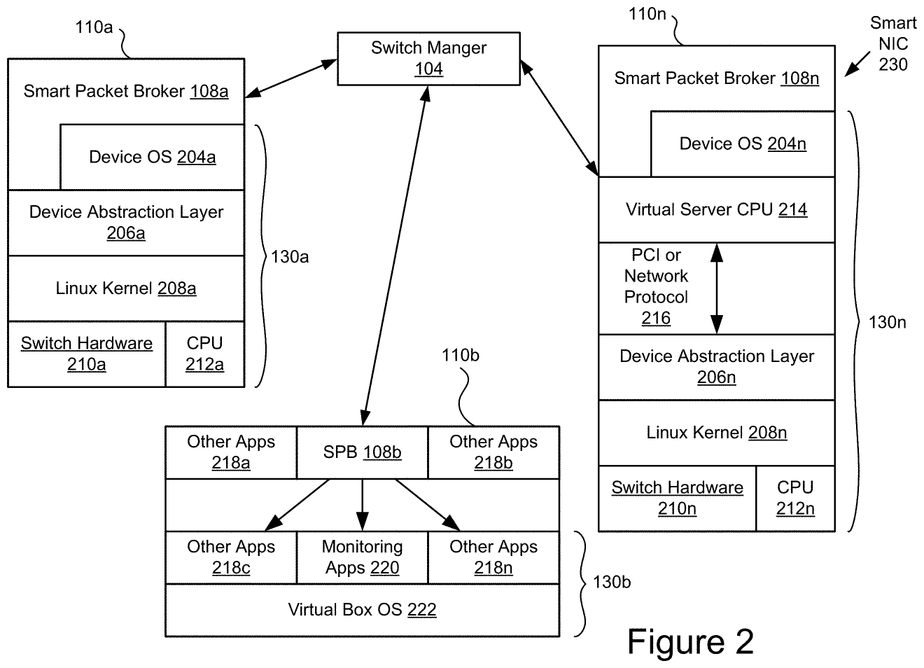

In some implementations, the switch 110 may include a switching system 130, which may include a switch fabric and/or other switching hardware and, in some instances, a processor capable of executing software, as described in reference to FIG. 2, although it should be noted that the switching system 130 may be implemented on a virtual machine. For instance, a processor may be used to program the switch fabric to look for and route data packets. A switch fabric may include a series of digital switches that may be programmatically toggled so that, as network traffic passes through the digital switches, it is diverted in real time.

Some implementations of the switching system 130 may use a switch fabric because the bandwidth of incoming data is too great for a solely virtual system to handle. For instance, a non-limiting example switching system 130 with 48 ports of one hundred gigabytes each may exceed the capabilities of a virtual system. It should be understood in reference to this example that, as technology advances, virtual systems may become more capable but the amount of data may also continue to rise relative to available throughput thus perpetuating the issue.

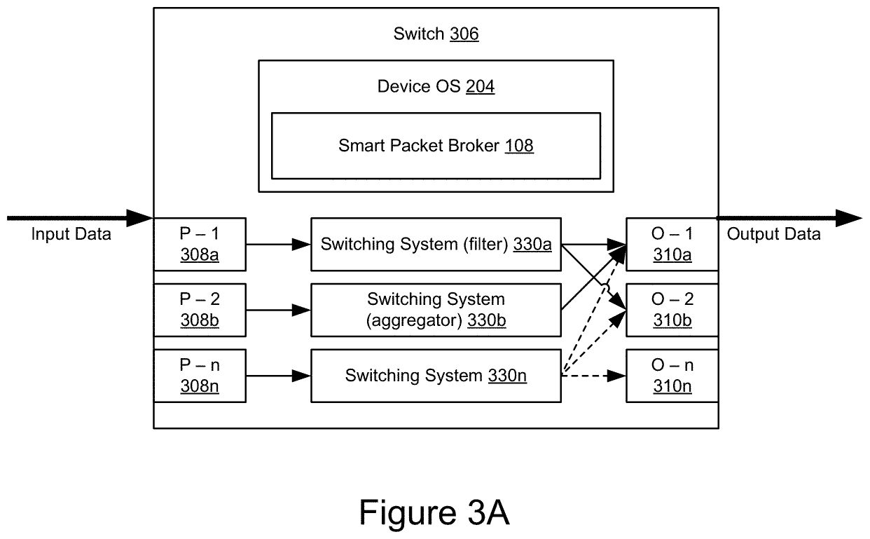

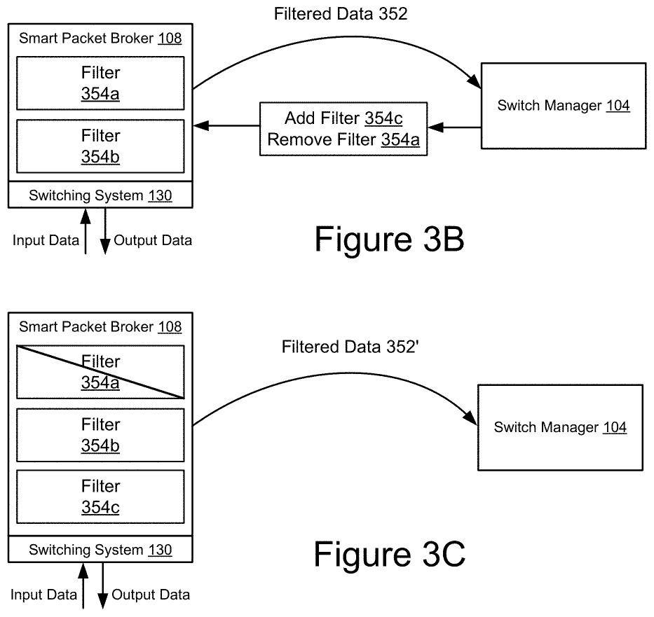

The switch 110 or switching system 130 may include a plurality of ports, such as input and output ports, and be configured to switchably couple sets of ports from the plurality of ports. For example, a first set of ports may have a first port mapped to a second port, a second set of ports may have a third port mapped to a fourth port, and so on and so forth. The switching system 130 may switchably couple these ports based on the manner in which the ports are mapped, the data being forwarded, and/or the filters that are applied (e.g., see FIG. 3A). Any combination of ports may be mapped any number of times based on the configuration of the switch 110. The ports may be wired, wireless, and/or virtual ports, depending the implementation. Aspects of the hardware, such as the switching system 130 of the switch 110, may be a networking device from a supplier, such as but not limited to Edge-Core™ or Mellanox™, which may be capable of interacting with various hardware and/or software components, such as the switch manager 104 and/or smart packet broker 108. In some instances, the switch 110 that has less suitable processing ability may be upgraded with a SmartNIC or other enhanced processing capability to allow it to be repurposed using the technology described herein to perform new operations.

In some implementations, a smart packet broker 108 may include computer logic, such as hardware logic, software, code, routines, etc., executable by a processor to perform operations described herein. For instance, the smart packet broker 108 may be installed and executable on the switch 110, such as by a processor of the switching system 130.

In some implementations, the switch 110 may not initially have underlying NPB software installed and may simply utilize the SONiC™ operating system and switching software to control switching hardware 210 (see FIG. 2) of the switch 110 to perform routine network switching functionality. In such implementations, the smart packet broker 108 may be installed and run on top of or in place of the operating system to enhance the capabilities of the switch 110 as discussed elsewhere herein.

In some instances, a switch 110 may include multiple instances of the switching system 130 and/or instances of the smart packet broker 108 controlling the switching system(s) 130. Depending on the implementation, multiple smart packet brokers 108 may control a single switching system 130, or a single smart packet broker 108 may control multiple switching systems 130, which may act together or individually as an NPB. Other variations are also possible and contemplated.

A switch manager 104 may include computer logic executable by a processor to perform operations described herein. As illustrated, a switch manager (referred to generally as 104 and in specific instances as 104a, 104b, 104c, and 104n) can be flexibly configured and may be located on premises or remotely located depending on the implementation. For example, the switch manager 104a may be located on a computing system 120b, on a device at a computing center 122, on a device in in network 132 such as on a switch 110n or another device (e.g., a device behind a firewall with a switch 110n and communicatively coupled with the smart packet broker 108), although it should be noted that other implementations are possible and contemplated herein. The system 100 may include multiple instances of the switch manager 104, or it may be located at different network locations and/or distributed across multiple devices.

A switch manager 104 may communicate with one or more smart packet brokers 108 to configure the smart packet brokers 108, install, remove, enable and/or disable filters on the smart packet brokers 108, control logical rules of the smart packet brokers 108 and, thereby, the switching of the switch hardware 210, etc., as described in further detail throughout this description. For instance, the switch manager 104 may dynamically change filters or other operations of the smart packet brokers 108. For example, the switch manager 104 may periodically (e.g., every 24 hours, in response to a detected condition, at a configurable interval, etc.) pole the smart packet broker(s) 108 for data (e.g., logs, configuration data, etc.) and/or push configuration data to the network packet broker(s), as described in further detail below.

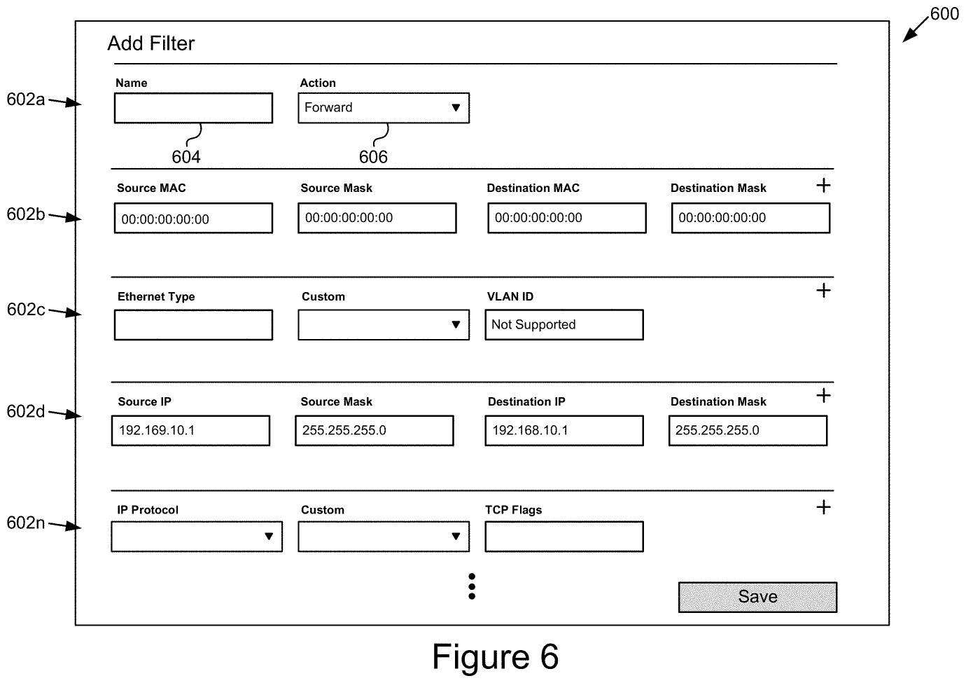

In some implementations, the switch manager 104 may be communicatively coupled with a switch management service 118 operating on a computing system, such as a computing system 120a, which may comprise a cloud-based computing system, centralized computing system, or an on-premises server, depending on the configuration. For instance, one or both of the switch management service 118 and the switch manager 104 may cooperate to receive configuration data for the smart packet broker 108, for example, via various computer or graphical interfaces, such as the graphical interface described in reference to FIG. 6. For example, a client-side instance of the switch manager 104 may be executed on a client device (e.g., computing system 120b), a server-side instance of the switch manager 104 may be executed on the switch 110n or a computing device in the computing center 122, and the switch management service 118 may be executed on a cloud server (e.g., the computing system 120a), although numerous other variations are also possible and contemplated.

The system 100 may include one or more computing systems 120a and 120b (also referred to generally as simply 120). A computing system 120 may include data processing, storing, and communication capabilities. For example, a computing system 120 may include one or more computing devices (e.g., laptop, desktop, mobile device, etc.), hardware servers, server arrays, storage devices and/or systems, etc. A computing device as used herein may also comprise the foregoing depending the implementation. In some implementations, a computing system 120 may include one or more virtual servers, which operate in a host server environment. Any other suitable computing devices or systems are also possible and contemplated.

Depending on the implementation, a computing system 120a or 120b or device may include a processor (e.g., virtual, physical, etc.), a memory, a power source, a communication unit, and/or other software and/or hardware components, such as a display, graphics processor, wired or wireless transceivers, keyboard, camera, sensors, firmware, operating systems, drivers, various physical connection interfaces (e.g., USB, HDMI, etc.). A computing system 120 or device may couple to and communicate with one another and the other entities of the system 100 via the network 102 using a wireless and/or wired connection. In some implementations, a computing system 120 may include a web server that receives and processes data requests and provides instructions to other computing systems, switches 110, or devices.

In some implementations, the computing system 120a may execute a switch management service 118, which may include hardware and/or software logic adapted to communicate with and provide instructions to one or more other components of the system 100, such as a switch manager 104. In some instances, it may provide graphical interfaces via which a user may interact to provide configuration details to a switch manager 104 and/or smart packet broker 108.

As illustrated, in some implementations, the system 100 may include a computing center 122, which may represent one or many computing devices operated together, for example, by an organization, such as a server farm, data center, etc. The computing devices of the computing center 122 may comprise or be included in a cloud, behind a firewall, or within a local area network 126, for example. In some instances, as illustrated, the computing center 122 may include several switches 110a, 110b, 110c, and 110d, etc., organized in a parallel, serial, and/or hierarchical arrangement, such as a bus, ring, star, or tree network topology 128. While a specific arrangement is shown, any suitable network topology is applicable. In some instances, the switches 110 or other components of the computing center 122 may be coupled via one or more network component(s) 124, such as routers, modems, etc. Additionally, in some implementations, the computing center 122 may include other devices, topologies 136, maps, or networks of devices coupled with the network components 124 and/or switch manager 104b.

In some implementations, each of the switches 110a, 110b, 110c, and 110d may be coupled with a local or wide area network, such as the VLANs 112a, 112b, 112c, and 112n, respectively. For instance, each of the switches 110a . . . 110d may manage network traffic internally or externally to the computing center 122. For instance, as described below, a switch 110 may process data between one or more input ports and one or more output ports.

In some implementations, as illustrated, a computing center 122 may include one or more switch managers 104b coupled with some or all of the switches 110a . . . 110d of the computing center 122. For instance, a switch manager 104b may be adapted to communicate with smart packet brokers 108 operating on each of the switches 110a . . . 110d. For instance, because of the decentralized management of the switches 110 or smart packet brokers 108 by the switch manager 104b, the computing center 122 may be able to scalably add or reassign (e.g., using the switch manager 104b) switches 110 or smart packet brokers 108 to adjust to changing network conditions.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), fabric protocols (e.g., internal fabric based on Ethernet, InfiniBand, PCI Express (PCIe), NVM Express Over Fabric (NVMeOF), etc.), or other known protocols.

FIG. 2 illustrates a block diagram showing communication between a switch manager 104 and one or more switches 110a . . . 110n. As illustrated, various devices may act as network packet brokers and may communicate with a switch manager 104. For instance, the smart packet broker may be executed on a switch 110a, a virtual switch 110b, or another type of device capable of network switch functionality, such as a SmartNIC 230. An advantage of the technology described herein may include that various off the shelf hardware may be used with a cloud management system. For instance, the smart packet broker 108 may allow a flexible, scalable hardware-agnostic implementation. It should also be noted that although each switch 110 is illustrated as a separate device, a single device may include multiple switches 110 or switching systems 130.

The smart packet broker 108 and/or switch manager 104 may be used with various switch configurations, for example, they may simultaneously or separately be used with hardware having 8 ports, 36 ports, 48 ports, virtual ports, or various other configurations. For instance, Edge-Core™, Mellanox™, Nvidia™, Broadcom™, or other manufactures may produce various device configurations suitable to meet varied network requirements. The technology described herein may beneficially allow various devices to adaptably or interchangeably be used to implement the functionality described herein, for example, of a network packet broker.

As described above, a switch manager 104 may manage one or more switches 110. For instance, a centralized switch manager 104 may configure and/or maintain multiple switches 110. For instance, while the logic (e.g., the smart packet broker 108) for controlling the switch hardware 210 may run on a switch 110, the switch manager 104 may be running on a blade server (e.g., on a virtual machine) and instruct the smart packet broker 108 which rules, templates, filters, operations, etc., to perform for which packets. Responsive to receiving the instructions from the switch manager 104, the smart packet broker 108 may filter data back to the switch manager 104, which may receive corresponding filtered data from other smart packet broker 108 instances, process it, and determine further configuration settings, filters, and/or remediation actions to apply to the switches 110 on which the smart packet brokers 108 are installed.

Accordingly, the switch manager 104 may manage and coordinate multiple smart packet brokers 108. For example, the switch manager 104 may execute on a physical or virtual machine and be configured to manage one or more (e.g., 50) switches 110, each running an instance of the smart packet broker 108, thereby providing cooperation between the smart packet brokers 108 to dynamically adjust their operations in response to changing network conditions or needs. In some embodiments, processing may be pushed to, or pulled (performed on the switch manager 104) from the switches 110 for load balancing, e.g., so as to reduce computing resources used by switches 110 in some instances.

A switch 110a may include a smart packet broker 108a and a switching system 130a. In some implementations, a switching system 130a may include a device OS 204a, device abstraction layer 206a, Linux kernel 208a, switch hardware 210a, and/or CPU 212a.

Depending on the implementation, the smart packet broker 108a may run on top of or in place of the device OS 204a. For example, the device OS 204a may comprise a standard switch fabric operating system that may be pre-loaded on many networking devices, or another operating system, firmware, etc. In a standardized operating system implementation, the smart packet broker 108a is generally able to run on the device OS 204a and interact with the switching system 130a. This advantageously allows the smart packet broker 108a to run on a variety of devices, provide functionality that was not previously available with the device OS 204a (e.g., upon initial installation), and thereby further improve the flexibility, scalability, and customizability of implementations of the technology described herein.

A device abstraction layer 206a may allow a smart packet broker 108a and/or device OS 204a to communicate with and/or control switch hardware 210a. The device abstraction layer 206a may be a switch abstraction interface that knows which switch hardware 210a (e.g., which ports and switches) is available and how to control it. The device abstraction layer 206a may be operated on the smart packet broker 108a, device OS 204a, or another component of a switch 110a.

In some implementations, the switch 110a may include a Linux or other kernel 208a, which may provide various services to the device OS 204 and/or the smart packet broker 108a, for example, for use of the CPU 212a, memory, or other components.

In some implementations, the switch hardware 210a may include one or more input and/or output ports (e.g., by way of a NIC), a switch fabric, and/or other hardware. For instance, a switch fabric may include a microchip with a series of digital switches for routing packets. For instance, as described above, a switch fabric may include switching units that route data, for example, between ports. A hardware switch fabric may be tailored to handle hundreds of gigabytes of incoming data packets far more efficiently, for example, than a virtual implementation of a switch fabric. The switch hardware 210 may filter data, act as a firewall to block certain traffic, route data, or provide other operations, as described elsewhere herein.

The CPU 212a may include one or more processors that execute instructions provided by other components of the switch 110a. The CPU 212a may program the switch hardware 210a using the device abstraction layer 206a and then, after programming, wait for instructions, for example, by the smart packet broker 108a or device OS 204a to perform other operations. A processor may execute software instructions by performing various input, logical, and/or mathematical operations. The processor may have various computing architectures to method data signals (e.g., ARM, X86, CISC, RISC, etc.). The processor may be physical and/or virtual and may include a single core or plurality of processing units and/or cores. In some implementations, the processor may be coupled to a memory via a bus to access data and instructions therefrom and store data therein.

The switch 110b may represent a virtual switch, for example, which may provide switching operations on a virtual machine on a server rack that emulates switch hardware 210. Similar to the switch 110a, the switch 110b may include a smart packet broker 108b, a switching system 130b, other applications 218a, 218b, 218c, and 218n, and/or monitoring apps 220. The virtual switching system 130b may include a virtual box OS 222 that receives incoming data, provides switching operations, and, in some instances, outputs data through physical or virtual ports. For example, the virtual box OS 222 may emulate switching hardware.

The other applications 218a . . . 218n may perform other operations on the switch 110b for operating the switch 110b, providing other general applications (e.g., in instances where the virtual switch 110b is a computer configured to run other applications). Similarly, one or more monitoring applications 220 may operate on the switch 110b to monitor incoming and/or outgoing data packets.

The switch 110n may represent a SmartNIC 230, which may be a network interface controller with processing capabilities beyond just core NIC functions, as described above. For example, the switch 110n may run a smart packet broker 108n and a switching system 130n. It should be noted that one or more of the components or operations of the switch 110n may be interchanged or added to those of the other switches 110a and 110b. For instance, the switch 110a may include the network protocol 216 of the switch 110n. The technology described herein may allow a smart NIC 230 to be used as a network packet broker.

In the illustrated example implementation, the switch 110n may include a device OS 204n, device abstraction layer 206n, Linux kernel 208n, switch hardware 210n, and/or CPU 212n, similar to those described above.

In some implementations, the switch 110n may include a virtual server CPU 214 that may, for example, load software such as the smart packet broker 108n or components thereof, thereby providing similar functionality as that provided by specialized devices on a generic or repurposed device.

In some implementations, the switch 110n may include a PCI or network protocol 216, which may provide interaction between the virtual server CPU 214, smart packet broker 108n, or device OS 204n and the other components of the switch 110n, such as the device abstraction layer 206.

For example, by encapsulating the protocol 216 between the device OS 204n and the device abstraction layer 206n, a potential constraint that the device OS 204n and the switch hardware 210n (or other switching system 130n components) be running on the same hardware device may be removed. This may allow hardware and software to be dispersed in varying and efficient configurations.

In some implementations, the protocol 216 may be session-based with a delivery guarantee. For instance, time stamping may be handled by the device OS 204n. In an effort to maintain efficiency, a device abstraction layer 206n application programming interface may be encapsulated in the TCP/IP protocol. Additional commands may be added for control and to maintain information about the device abstraction layer 206n, because it may be on different hardware from the device OS 204n.

FIG. 3A is a block diagram illustrating an example switch 306. As illustrated, a switch 306 may include a smart packet broker 108 running on a device OS 204. The switch 306 may also include one or more input ports 308a, 308b, and 308n (e.g., corresponding to a switching system 130) for receiving input data and one or more output ports 310a, 310b, and 310n for outputting data. As illustrated, the switch 306 may include multiple switching systems 330a, 330b, and 330n, which may correspond to switching systems 130, whitebox switches, or NICs described above.

In some implementations, the smart packet broker 108 may include software that provides network packet broker functionality to a switch that does not have underlying network packet broker software installed. The smart packet broker 108 may interact with one or more controllers of switching systems 330a . . . 330n on the switch 306. For instance, controllers (e.g., smart NIC controllers) on each switching system 330 may monitor and/or manage network traffic that passes through the switch 306, for example, via the ports 308 and 310.

As described in further detail below, the smart packet broker 108 may also establish or control port maps, operations, filter templates, or other operations of a switch 306.

As illustrated, the switch 306 may include multiple input streams 308a . . . 308n. Each input stream may have its own switching system 330 or NIC (e.g., SmartNIC) or a switching system 330 may implement rules for multiple input streams. An input stream may originate from a physical port 308 that controls traffic in or out of a network. For instance, an input stream at one or more ports 308 may originate from one or more ethernet ports connected to the Internet (e.g., via other network components, directly, etc.).

In some implementations, an input stream on a port 308 may be a virtual input stream (e.g., a stream of inputs on a cloud or computing device). For example, the switch 306 may virtually monitor traffic into and out of a virtual network. As an illustration, an input stream may be an input stream into a cloud supported network (e.g., a network where one or more servers are remote). The cloud-supported network may have a single device or definable set of devices through which network traffic may be monitored.

In some implementations, a switch 306 may include more than one switching system 330, where each switching system 330 may perform the same or different functions. As an example, a first switching system 330a may implement a filter, while a second switching system 330b may implement an aggregator. An aggregator may combine different input feeds into a single output feed. For example, the second switching system 330b may receive input from an input port P-2 308b and redirect the data stream into the output O-1 310a in combination with output from the first switching system 330a.

In some implementations, a switching system 330 may perform various types of NPB operations. For instance, a switching system 330 may perform filtering, aggregation, replication, a duplication, slicing, load balancing, packet manipulation, header stripping, or any other NPB operation or combination thereof. In some instances, multiple switching systems 330 may perform different operations or may perform the same operation. For example, multiple switching systems 330 may perform a filter (either with the same or different filter conditions).

In some implementations, a smart packet broker 108 may instruct a switching system 330 to filter out data packets satisfying a certain condition, for example, to facilitate monitoring of network traffic. For instance, in an effort to identify a security threat, the smart packet broker 108 may apply a filter to the network traffic coming from a first port P-1 308a. The filter may direct traffic having a certain origin or other attribute to a certain output O-1 310a. For instance, the filter may direct traffic from a certain geographical region to a first port O-1 310a for analysis of a security threat by a computing device (e.g., the smart packet broker 108, a switch manager 104, or another computing device). In some instances, the filter may direct traffic from a trusted or high-bandwidth origin, such as YouTube® to a trusted destination, for example, on a second port O-2 310b. Because video typically does not include computer threats it may be filtered from a port where analysis is performed in order to preserve computer resources of a system performing the analysis. Similarly, if a threat is detected, the smart packet broker 108 may redirect data packets to a particular output port no port at all, effectively creating a firewall to block traffic.

In some implementations, the smart packet broker 108 may change the function of a switching system 330, which may increase the versatility and responsiveness of the switch 306. For instance, it may be determined that a certain filter should be applied to one or more input data streams. The smart packet broker 108 may leverage functionality of one or more unassigned switching systems (e.g., 330n), for example, by reassigning the switching systems 330 to implement the filter. These improvements may allow changes to be made without shutting down the switch 306, rather than temporarily shutting down to make changes, which may be required by conventional network switches and may result in security gaps. Because the technology described herein allows switching systems 330 to be updated or reassigned without shutting down the switch 306, traffic may be continuously monitored, thereby reducing network vulnerabilities caused by coverage gaps.

FIGS. 3B and 3C are block diagrams illustrating example communication between a smart packet broker 108 and a switch manager 104. It should be noted that although the operations illustrated are filters, other operations, such as those NPB operations described elsewhere herein, may also be performed.

As illustrated, based on a request received from a switch manager, the smart packet broker 108 may implement multiple filters 354a and 354b using a switching system 130. The filters 354a and 354b may be applied to input data to, for example, control packets to output via certain ports. The smart packet broker 108 may cause the switching system 130 to filter out and/or duplicate certain data for analysis based on the request. In some implementations, the smart packet broker 108 may filter the filtered data 352 to (communicate the filtered data 352 to) the switch manager 104 or another intended component, which may process the filtered data 352 to detect certain conditions. For instance, the switch manager 104 may detect an increase in volume or latency, traffic from certain sources, data patterns, or other conditions. By sending certain information, such as the filtered data 352, the smart packet broker 108 may provide improved visibility into the operation and traffic of a network. In a further example, the switch manager 104 may have instructed other smart packet broker 108 instances operating on other switches 110 to filter similar data to the switch manager and the switch manager 104 may use the different instances of filtered data to detect, verify, and validate its findings.

The switch manager 104 may be programed to automatically perform certain operations, such as changing or implementing a filter in response to certain conditions. For example, the switch manager 104 may instruct the smart packet broker 108 to add a new filter 354c and/or remove a filter 354a. In this example, the new filter 354c may filter additional data to the switch manager 104 so the switch manager 104 can further confirm an initial result before informing a stakeholder or instructing the smart packet broker 108 to execute an action. In another example, the filter 354c may cause the switching system 130 to prevent the forwarding of the data or perform some other function. The smart packet broker 108 may, upon receiving the instruction, automatically program the switching system 130 to active/deactivate/install/uninstall the filters.

In some implementations, the smart packet broker 108 may be configured to store the filtered data and periodically send the data to the switch manager 104. In some instances, the smart packet broker 108 may automatically strip certain information in order to reduce the storage space and or bandwidth used when storing or transmitting the data. By stripping certain information, data privacy concerns may also be reduced.

As illustrated in FIG. 3C, the filter 354a has been removed and replaced with the filter 354c. For instance, in some implementations, the new filter may change the information transmitted for analysis. For example, filtered data 352′ may be stored and/or sent to the switch manager 104 for processing, monitoring, and/or detection of certain conditions.

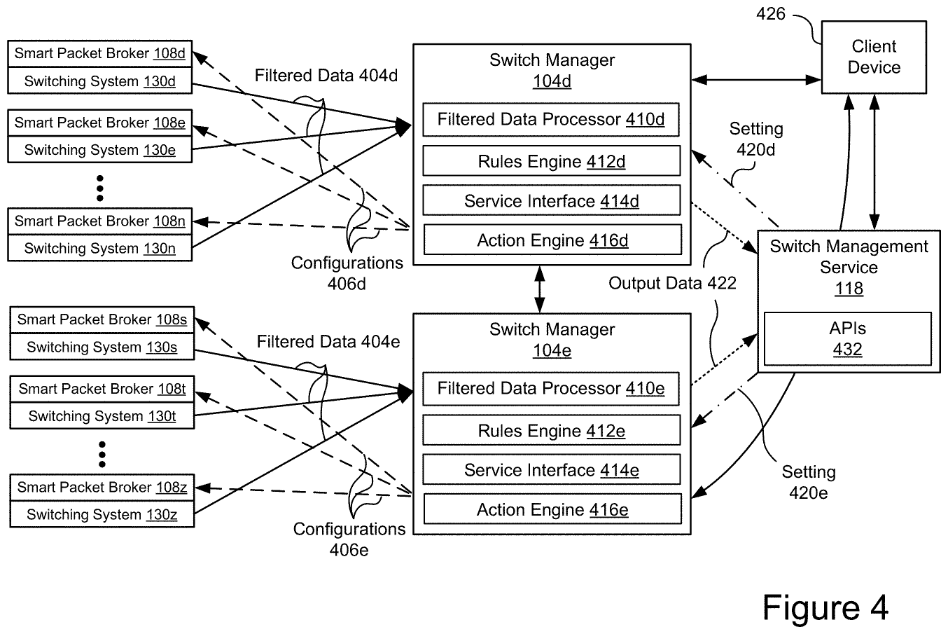

FIG. 4 is a block diagram illustrating an example implementation of a multi-level hierarchical structure showing communication between smart packet brokers 108d . . . 108z, switching systems 130d . . . 130z, switch managers 104d . . . 104e, a switch management service 118, and a client device 426, although other implementations than the illustrated examples are possible.

A switch management service 118 may be located on a server or cloud device separate from a smart packet broker 108 and/or switch manager 104, as described above. The switch management service 118 may electronically communicate with one or more client devices 426 and/or switch managers 104d . . . 104e to perform operations, such as configure smart packet brokers 108 and switching systems 130. A client device 426 may include one or more computing devices having data processing and communication capabilities, such as a laptop or desktop computer, server appliance, smartphone, or another device. For example, the switch management service 118 may provide various graphical configuration interfaces, such as those described in reference to FIG. 6 to configure operations, such as filters, network conditions, and other settings.

In some implementations, a switch management service 118 may include application programming interfaces 432, which allow one or more switch managers 104d . . . 104e to communicate with the switch management service 118. For instance, the switch management service 118 may transmit a setting file 420d and 420e to each of the switch managers 104d and 104e respectively, although other data may be transferred. Switch managers 104 may, in some instances, output data 422 to a switch management service 118, for example, acknowledging receipt and/or execution of settings 420. Additionally, some implementations allow a client device 426 to communicate directly with one or more switch managers 104.

Switch manager(s) 104 may transmit configuration files 406d . . . 406e to smart packet brokers 108d . . . 108z, which may in turn configure switching systems 130d . . . 130z, as described above. For instance, a switch manager 104d may transmit configurations 406d to one or more of a smart packet broker 108d, smart packet broker 108e, and smart packet broker 108n, which may be coupled with one or more of switching system 130d, switching system 130e, and switching system 130n, respectively. Similarly, a switch manager 104e may transmit configurations 406e to one or more of a smart packet broker 108s, smart packet broker 108t, and smart packet broker 108z, which may be coupled with one or more of switching system 130s, switching system 130t, and switching system 130z, respectively.

As described in further detail in reference to FIGS. 3B and 3C, a switch manager 104d or 104e may send to and receive data from smart packet brokers 108. Further, in some implementations, switch managers 104d and 104e may communicate with each other directly or via the switch management service 118.

In some implementations, as described in reference to FIGS. 3B and 3C, smart packet brokers 108 and/or switching systems 130 may transmit filtered data 404d . . . 404e data to switch managers 104. For instance, a smart packet broker 108 may store filtered data or statistics and periodically (e.g., every hour, 24 hours, upon request, upon detection of a condition, etc.) transmit the data or statistics to a switch manager 104.

In some implementations, a switch manager 104 may include components, such as computer logic executable to perform certain operations with respect to filtered data 404, settings 420, and/or configurations 406. For instance, each switch manager 104d and 104e may include a filtered data processor 410d or 410e, rules engine 412d or 412e, service interface 414d or 414e, and/or action engine 416d or 416e, respectively.

For example, a filtered data processor 410 may include computer hardware or software logic configured to process filtered data to detect defined network conditions, as described above. For instance, the conditions may include a network traffic volume, defined traffic pattern, traffic from a specific origin going to a specific destination, a specific data type, or other attributes.

A rules engine 412 may include computer hardware or software logic configured to implement various rules with various attributes based on detected conditions. For instance, rules may include a decision tree, trained neural network or other machine learning model, or another suitable decision engine dictating whether certain data may be monitored, whether configurations 406 may be controlled by an external switch management service 118, which information to store, send, encrypt, or strip, and/or which actions to perform in response to detected conditions, although other implementations are possible and contemplated herein. For example, the rules engine 412 may implement a rule directing that when certain network conditions (e.g., an increase in network traffic, detection of certain packets, detection of a hardware change, etc.) are detected, a switching system 130 may be reassigned or a new filter may be implemented, among other rules described elsewhere herein.

A service interface 414 may include computer hardware or software logic programmed to interface with a client device 426 and/or switch management service 118 to allow the switch manager 104 to be programmed, for example, by receiving settings 420. For instance, the service interface 414 may receive modifications to rules, conditions for the filtered data processor 410, actions for the action engine 416, etc. Additionally or alternatively, the service interface 414 may provide service, such as software or firmware updates to a one or more smart packet brokers 108.

Additionally or alternatively, the service interface 414 may allow operating system, bios, or other updates to the switch manager 104. For instance, the service interface 414 may allow a switch manager 104 to periodically check for settings 420 or receive instructions for updating firmware. In some implementations, the service interface 414 may allow the switch manager 104 and/or smart packet broker 108 to boot into different firmware versions for testing.

An action engine 416 may include computer hardware or software logic programmed to take certain actions, for example, in response to detection of certain conditions by the filtered data processor 410 and satisfaction of rule conditions by the rules engine 412. For instance, the action engine 416 may cause configurations 406 to be transmitted to a smart packet broker 108, output data 422 to be transmitted to a switch management service 118, or implementation of various other actions, as described in reference to the switch manager 104 throughout this description.

In some implementations, the configurations 406 may beneficially separate components of the configuration. For instance, a configuration may include one or both of a port map and a filter. It should be noted that although a filter is described herein, other operations, such as aggregation, replication, a duplication, slicing, load balancing, packet manipulation, header stripping, or any other NPB operation are possible and contemplated herein.

Because each switching systems 130d, 130e, 130n, 130s, 130t, and 130z may include different hardware configurations, such as different features, ports, etc., the configuration may separate a port (or other switching system-specific configuration) map with a filter. For instance, a port map may describe a layout of switching hardware and/or ports, while a filter or filter template may describe the actual data type or attributes filtered. A port map may be specific to each type or configuration of switch 110/switching system 130.

Accordingly, once a port map is established for a switching system 130, the smart packet broker 108 may apply a filter using the port map, thereby allowing the filter to be applied using the specific port and/or switching hardware configuration of the switching system 130 without having to specifically program a different filter or other operation for each separate switching system configuration. For example, because the port map may adapt a filter to the specific hardware of various switching systems 130, filters may be quickly changed, updated, or propagated among various devices without requiring that the filters be recoded or configured for each specific device.

For example, a single filter may be pushed to several different switching systems 130 (e.g., via one or more switch managers 104 and smart packet brokers 108), despite the distinct configurations (hardware, features, etc.) of the switching systems 130. As such, these improvements further improve the flexibility and scalability of the technologies described herein.

The creation and configuration of a filter or other operation is described in further detail in reference to the graphical user interface in FIG. 6 below.

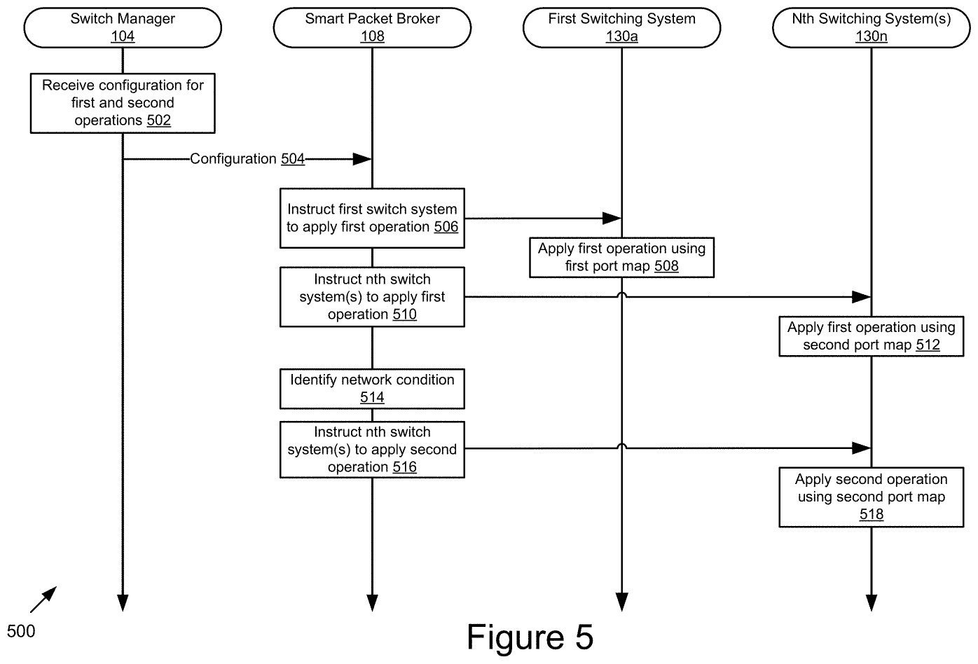

FIG. 5 is a signal diagram 500 illustrating example interactions between a switch manager 104, smart packet broker 108, and multiple switching systems 130. For instance, the switch manager 104 may interact with a smart packet broker 108, which may, in turn, interact with a first switching system 130a and one or more nth switching system(s) 130n, for instance, each switching system 130 may include a controller that may receive instructions and/or configuration from a smart packet broker 108, although other implementations are possible and contemplated herein.

In some implementations, at 502, the switch manager 104 may receive configuration details for a first and/or a second operation, such as a filter or other packet manipulation operations, as described above. For instance, the switch manager 104 may receive a settings file, an initial administrator setting (e.g., via a client device 426 or switch management service 118), or other automatically or manually generated configuration. For example, the configuration for the first and second operations may include defined filter attributes, as described elsewhere herein.

At 504, the switch manager 104 may transmit a configuration file to a smart packet broker 108. For example, the switch manager 104 may transmit a first request instructing the first smart packet broker 108 to apply a first filter having a first defined set of attributes to first network traffic being processed by a first switching system 130a. In some implementations, in the same or a different communication, the switch manager 104 may send a second request instructing the smart packet broker 108 to apply a second filter having a second, different set of attributes, for example, in response to detection of a network condition.

At 506, the smart packet broker 108 may instruct a first switch system 130a to apply the first operation. The first switch system 130a may include a smart network interface card, physical network switch 110, or virtual network switch 110, for example, as described above.

At 508, the first switching system 130a may apply the first operation using a first port map. The first switch system 130a may include a plurality of ports and may be configured to switchably couple certain of the ports together. For example, the smart packet broker 108 may apply the first filter using a first port map of the first switching system 130a.

The first switching system 130a may apply the operation to first network traffic received by the first switching system 130a. For example, the first switching system 130a may determine which packets received at a first port of the first switching system 130a to forward to a second port of the first switching system 130a based on the defined operation and a port map of the first switching system 130a.

In some implementations, at 510, the smart packet broker 108 may instruct the nth switch system 130n to apply the first operation and, at 512, the nth switching system 130n may apply the first operation using a second port map. For instance, the second port map may be specific to the nth switching system 130n. For example, the nth switching system 130n may apply the first filter with the first set of attributes using the second port map of the nth switching system 130n to determine which packets to route between a third and fourth port of the nth switching system 130n.

In some implementations, the first switching system 130a may include a different hardware configuration, feature set, quantity of ports, or other sets of attributes than the nth switching system 130n. The first port map and second port map respectively may allow the first filter to be applied on either switching system 130a or 130n, despite their differences.

In some implementations, at 514, the smart packet broker 108 may identify a network condition. For example, the smart packet broker 108 may identify a change in a network condition, such as an increase in volume of network traffic relative to a threshold, a defined pattern, a change in network hardware, a threat, an increase in network complexity, a deviation from an expected pattern, or other condition. For example, detecting the network condition may include receiving filter data matching a set of defined attributes from a first and/or second switching system 130a or 130n and processing the filter data to detect the network condition. For instance, the first operation may include a filter that sends data to the smart packet broker 108 when it detects a defined network condition.

For example, a first operation may include a filter that passes through video network traffic, but filters network traffic from a certain IP address or geographic region. The switching system 130 (e.g., 130a) that detects the filtered network traffic may forward it to the smart packet broker 108 (or another device), which may detect the network condition based on the receipt or contents of the filtered traffic.

Responsive to identifying the network condition, the smart packet broker 108 may determine configuration of the second operation and instruct the nth switching system 130n (or 130a or smart packet broker 108) to apply the second operation. For instance, the second operation may be configured to confirm the network condition, address a threat represented by the network condition, adapt to increasing traffic volume, execute a remedial action, or perform another operation.

At 516, the smart packet broker 108 may instruct one or more nth switch systems 130n to apply a second operation having a second set of defined attributes, for example, in response to identifying the network condition. For instance, the smart packet broker 108 may send a second request instructing the nth switching system 130n to apply a second filter to the network traffic processed by the nth switching system 130n.

At 518, the nth switching system 130n may apply a second operation using a second port map. In some implementations, the second operation may replace the first operation on the nth switching system 130n, for example, using the second port map specific to the nth switching system 130n, although, it should be noted that the nth switching system 130n may apply the second operation in addition to the first operation.

In instances where the identified network condition includes a security threat, the second operation may include switching off traffic corresponding to the network threat in order to implement a firewall or other operation.

Although not shown in the example signal diagram 500, other operations are possible, as described throughout this disclosure. For example, in response to an increase in network traffic volume, switching systems 130 may be added or replaced with higher-throughput systems. Once port maps are defined for the new hardware, the operations may simple be installed on the new switching systems 130 to allow them to continue performing the same operations.

FIG. 6 is an example graphical user interface 600 for developing and/or applying operations, such as filtering, packet slicing, header removal, etc., using a smart packet broker 108. The graphical user interface 600 may be generated, provided, or rendered by one or more of the switch management service 118, computing system 120b, client device 426, computing center 122, or another computing device coupled with the system 100. For example, a network administrator or engineer may instruct a switch manager 104 to coordinate with connected smart packet brokers 108 to apply an identified operation. Beneficially, the graphical user interface 600, as well as other interfaces, may be used to control multiple switches 110 simultaneously, which is not performed using conventional technologies, which must separately configure each switch 110/NIC. For example, as a result of the separation of operations from port maps and ability of each switch manager 104 or smart packet broker 108 to adaptably apply operations using its own configuration (e.g., using its own port maps), the operations (e.g., operation templates) defined in the graphical user interface 600 may be broadly applied across switches 110 having different configurations. For example, the defined operation may be applied using switches 110 with varying numbers, configurations, or connections to its ports.

In some implementations, the graphical user interface 600 may be organized in various categories or layers 602a, 602b, 602c, 602d, and 602n. Each layer 602 may expand or collapse depending on a level of detail of the operation being defined. For example, a first layer 602a may include information that is mandatorily entered, while subsequent layers decrease in importance, increase in level of detail, or provide options that are less frequently changed. In some instances, the graphical user interface 600 may dynamically update each layer 602 in response to information entered in a higher layer, thereby causing the information in each layer to adapt specifically to, for example, the selected action/operation. Similarly, each layer may be collapsed automatically or by a user in order to allow the user to focus on the specific information or type of information being defined. It should be noted that other information may additionally or alternatively be entered, such as definition of specific traffic pattern.

As illustrated, an operation may be named with a unique identifier at the graphical element 604. The operation or action (e.g., a filter, or filter operations, such as forward, split, etc.) may be defined using the element 606. For example, filters may be set up as described above using various details and functionality, such as with specific conditions (e.g., as described above) or filter events and actions, such as forwarding (e.g., to a location or port) or dropping packets.

Additional graphical elements may be provided in the graphical user interface 600 for inputting additional details or attributes (e.g., filter attributes) pertaining to the defined operation. For example, the attributes may define a filter that looks for data coming from a specific location, port, or data pattern, and routes the data to a second port. For example, routing information, such as a source MAC, a destination MAC, a source IP, a destination IP, or other routing addresses or combinations thereof may be defined. The operation may include other identifying and/or functional information, such as an ethernet type, masks associated with the various IP and MAC addresses, IP protocol, TCP flags, and so forth. While this example has been discussed with respect to a filter, it should be understood that various network traffic functions may be set using the format illustrated in FIG. 6.

In some implementations, a network administrator may wish to boot multiple combinations of operations. This may allow the administrator to run tests on different configurations prior to network-wide implementation to determine whether the network tool is performing as expected. Because uninterrupted network visibility may be important to a secure network, this functionality may help the administrator to test changes without potentially compromising the network, thereby improving network growth.

In the above description, for purposes of explanation, numerous specific details are set forth in order to provide a thorough understanding of the disclosure. It will be apparent, however, that the disclosure can be practiced without these specific details. In other instances, structures and devices are shown in block diagram form in order to avoid obscuring the disclosure. Moreover, the present disclosure is described below primarily in the context of adaptive packet broker technology; however, it should be understood that the present disclosure applies to monitoring any type of network communication.

It should be understood that unless expressly stated otherwise, the implementations, embodiments, and examples referenced herein are all non-limiting and intended to open-endedly illustrate various aspects of the technology. It should also be understood that language which refers to a list of items such as “at least one of A, B, or C” (example 1) means “at least one of A, B and/or C.” Likewise, it should be understood that language which refers to a list of items such as “at least one of A, B, and C” (example 2) means “at least one of A, B and/or C.” The list of items in example 2 is not required to include one of each item. The lists of items in both examples 1 and 2 can mean “only one item from the list or any combination of items in the list.” That is, the lists of items (in both examples 1 and 2) can mean only A, or only B, or only C, or any combination of A, B, and C (e.g., AB, AC, BC, or ABC).

It should be further understood that the terms “comprises,” “has,” “includes”, “comprising,” “having,” and/or “including” are open ended and when used in this specification, specify the presence of stated features, integers, steps, operations, elements, and/or components, but do not preclude the presence or addition of one or more other features, integers, steps, operations, elements, components, and/or groups thereof.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of a hardware embodiment, a software embodiment, or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Various general-purpose systems may be used with programs in accordance with the teachings herein, or it may prove convenient to construct more specialized apparatus to perform the required method steps. The required structure for a variety of these systems will appear from the description above. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method comprising:
receiving, at a first smart packet broker from a switch manager, a first request instructing the first smart packet broker to apply a first filter to first network traffic being processed by a first switching system associated with a switch fabric, the first switching system including a plurality of ports and configured to switchably couple sets of ports from the plurality of ports;
applying, by the first smart packet broker, the first filter to the first network traffic using the first switching system, the first filter having a first set of defined attributes; and
filtering, from the first network traffic, first data corresponding to the first set of defined attributes to the switch manager.

2. The method of claim 1, wherein:
the sets of ports include a first set of ports having a first port mapped to a second port; and
filtering the first data corresponding to the first set of defined attributes to the switch manager includes determining which packets received at the first port of the first switching system to forward to the second port of the first switching system.

3. The method of claim 2, further comprising:
responsive to filtering the first data to the switch manager, receiving, at the first smart packet broker from the switch manager, a second request instructing the first smart packet broker to block one or more of the plurality of ports; and
signaling the first switching system to block the one or more of the plurality of ports.

4. The method of claim 1, further comprising:
receiving, at a second smart packet broker from the switch manager, a second request instructing the second smart packet broker apply the first filter to second network traffic being processed by a second switching system that is different from the first switching system;
applying, by the second smart packet broker, the first filter to the second network traffic using the second switching system; and
filtering, from the second network traffic, second data corresponding to the first set of defined attributes to the switch manager.

5. The method of claim 4, further comprising:
receiving, at the first smart packet broker and the second smart packet broker from the switch manager, a second request instructing the first smart packet broker and the second smart packet broker to apply a second filter, the second filter being determined by the switch manager based on the filtered first data and the filtered second data, the second filter having a second set of defined attributes;
applying, by the first smart packet broker, the second filter to the first network traffic using the first switching system;
filtering, from the first network traffic, third data corresponding to the second set of defined attributes to the switch manager;
applying, by the second smart packet broker, the second filter to the second network traffic using the second switching system; and
filtering, from the second network traffic, fourth data corresponding to the second set of defined attributes to the switch manager.

6. The method of claim 1, further comprising:
responsive to the filtered data being received by the switch manager from other switching systems, receiving, at the first smart packet broker from the switch manager, a second request instructing the first smart packet broker apply a second filter to the first network traffic, the second filter having a second set of defined attributes that is different than the first set of defined attributes of the first filter;
applying, by the first smart packet broker, the second filter to the first network traffic using the first switching system; and
filtering, from the first network traffic, second data corresponding the second set of defined attributes to the switch manager.

7. The method of claim 1, further comprising:
redistributing further network traffic processed by the switch fabric based on at least the first data filtered to the switch manager.

8. The method of claim 1, wherein the first switching system comprises a smart network interface card (SmartNIC), a physical network switch, or a virtual network switch.

9. A method comprising:
sending, to a first smart packet broker, a first request instructing the first smart packet broker to apply a first filter to first network traffic processed by a first switching system, the first filter having a first set of defined attributes;
receiving first filter data corresponding to the first set of defined attributes from the first switching system;
detecting, based on the first filter data, a network condition;
determining, based on the network condition, a second filter; and
sending, to the first smart packet broker, a second request instructing the first smart packet broker to apply a second filter to the first network traffic processed by the first switching system, the second filter having a second set of defined attributes that is different from the first set of defined attributes of the first filter.

10. The method of claim 9, further comprising:
receiving second filter data corresponding to the second set of defined attributes from the first switching system;
processing the second filter data to confirm the network condition; and
executing a remedial action to address the network condition.

11. The method of claim 10, wherein the network condition includes one or more of an increase in volume of the first network traffic relative to a threshold and a detected pattern of first network traffic that corresponds to a defined pattern.

12. The method of claim 9, further comprising:
sending, to a plurality of other smart packet brokers respectively associated with a plurality of other switching systems, a corresponding first request instructing the plurality of other smart packet brokers to apply the second filter to network traffic processed by the plurality of other smart packet brokers; and
receiving other first filter data corresponding to the first set of defined attributes from the plurality of other switching systems, wherein detecting the network condition further includes processing the first filter data and the other first filter data corresponding to the first set of defined attributes to detect the network condition.

13. The method of claim 12, further comprising:
sending, to the plurality of other smart packet brokers, a second request instructing the plurality of other smart packet brokers to apply the second filter to network traffic processed by the plurality of other switching systems;
receiving other second filter data corresponding to the second set of defined attributes from the plurality of other switching systems;
receiving second filter data corresponding to the second set of defined attributes from the first switching system;
processing the second filter data to confirm the network condition; and
executing a remedial action to address the network condition.

14. A system comprising:
one or more processors; and
a non-transitory memory storing instructions that, when executed by the one or more processors, cause the system to:
receive, at a first smart packet broker from a switch manager, a first request instructing the first smart packet broker to apply a first filter to first network traffic being processed by a first switching system associated with a switch fabric, the first switching system including a plurality of ports and configured to switchably couple sets of ports from the plurality of ports;
apply, by the first smart packet broker, the first filter to the first network traffic using the first switching system, the first filter having a first set of defined attributes; and
filter, from the first network traffic, first data corresponding to the first set of defined attributes to the switch manager.

15. The system of claim 14, wherein:
the sets of ports include a first set of ports having a first port mapped to a second port; and
filtering the first data corresponding to the first set of defined attributes to the switch manager includes determining which packets received at the first port of the first switching system to forward to the second port of the first switching system.

16. The system of claim 15, further comprising:
responsive to filtering the first data to the switch manager, receiving, at the first smart packet broker from the switch manager, a second request instructing the first smart packet broker to block one or more of the plurality of ports; and
signaling the first switching system to block the one or more of the plurality of ports.

17. The system of claim 14, wherein the instructions further cause the system to:
receive, at a second smart packet broker from the switch manager, a second request instructing the second smart packet broker apply the first filter to second network traffic being processed by a second switching system that is different from the first switching system;
apply, by the second smart packet broker, the first filter to the second network traffic using the second switching system; and
filter, from the second network traffic, second data corresponding to the first set of defined attributes to the switch manager.

18. The system of claim 17, wherein the instructions further cause the system to:
receive, at the first smart packet broker and the second smart packet broker from the switch manager, a second request instructing the first smart packet broker and the second smart packet broker to apply a second filter, the second filter being determined by the switch manager based on the filtered first data and the filtered second data, the second filter having a second set of defined attributes;
apply, by the first smart packet broker, the second filter to the first network traffic using the first switching system;
filter, from the first network traffic, third data corresponding to the second set of defined attributes to the switch manager;
apply, by the second smart packet broker, the second filter to the second network traffic using the second switching system; and
filter, from the second network traffic, fourth data corresponding to the second set of defined attributes to the switch manager.

19. The system of claim 14, wherein the instructions further cause the system to:
responsive to the filtered data being received by the switch manager from other switching systems, receive, at the first smart packet broker from the switch manager, a second request instructing the first smart packet broker apply a second filter to the first network traffic, the second filter having a second set of defined attributes that is different than the first set of defined attributes of the first filter;
apply, by the first smart packet broker, the second filter to the first network traffic using the first switching system; and
filter, from the first network traffic, second data corresponding the second set of defined attributes to the switch manager.

20. The system of claim 14, wherein the instructions further cause the system to:
redistribute further network traffic processed by the switch fabric based on at least the first data filtered to the switch manager.
